(19) United States
(12) Patent Application Publication
(10) Pub. No.: US 2022/0349776 A1
(43) Pub. Date: Nov. 3, 2022

(54) FLEXIBILITY ASSESSMENT

(71) Applicant: Niba Solutions Limited, Cardiff (GB)

(72) Inventors: Brian JARVIS, Yate, Bristol (GB); Jonathan AVENT, Cardiff (GB); Thomas HILL, Cardiff (GB)

(73) Assignee: Niba Solutions Limited, Cardiff (GB)

(21) Appl. No.: 17/765,826

(22) PCT Filed: Oct. 5, 2020
(86) PCT No.: PCT/GB2020/052444

§ 371 Date: Mar. 31, 2022

(30) Foreign Application Priority Data
Oct. 4, 2019 (GB) 1914333.8

(51) Int. Cl. G01M 5/00; G01M 7/02

(52) U.S. Cl. CPC G01M 5/0066; G01M 7/022; G01M 7/025; G01M 5/0075

(57) ABSTRACT

A method to assess the integrity of a structure is provided and comprises the steps of: i) applying a sinusoidally varying force to the structure at a frequency or frequencies below the lowest frequency that could cause resonance in the structure whereby to set up a dynamic response dominated by the stiffness of the structure; and ii) monitoring the dynamic response of the structure. A device to assess the integrity of a structure is also provided.

The present invention relates generally to methods, devices and equipment for performing a flexibility/stiffness assessment on a surface/structure and particularly, although not exclusively to flexibility assessment by dynamic excitation.

There are many structures that require integrity assessment where a measurement of flexibility would provide vital data. This is particularly important when an invasive investigation is undesirable, for example in historic buildings (such as heritage properties). A conventional flexibility test would require applying some known load and measuring the deflection that results. This is not straightforward because some fixed reference is required from which deflections can be measured. Nearby points chosen as a reference are potentially affected by the loading. If a method can be found that will give the deflection from a known force without this drawback, it would offer substantial benefits.

The present invention seeks to provide improvements in or relating to structural integrity assessments.

An aspect of the present invention provides a method to assess the integrity of a structure, comprising the steps of: i) applying a sinusoidally varying force to the structure at a frequency or frequencies below the lowest frequency that could cause resonance in the structure whereby to set up a dynamic response dominated by the stiffness of the structure; and ii) monitoring the dynamic response of the structure.

The present invention also provides a device to assess the integrity of a structure, comprising: i) means for applying a sinusoidally varying force to the structure at a frequency or frequencies below the below the lowest frequency that could cause resonance in the structure whereby to set up a dynamic response dominated by the stiffness of the structure; and ii) means for monitoring the dynamic response of the structure.

The method/device may comprise a step of and/or providing means for determining or estimating the first natural frequency of the structure whereby to determine or estimate the lowest frequency that could cause resonance in the structure.

The lowest frequency that could cause resonance could also be thought of or described as the first natural frequency.

A typical method for finding the first natural frequency of a structure would be as follows:

A dynamic force is applied to the structure to be tested. The frequency spectrum of the force must contain a spread of frequencies that encompasses the first natural frequency of the structure. Typically, the force could take the form of an impulse, a random excitation, swept sine, chirps or other formats that have some content at the first natural frequency of the structure such that it produces a measurable response. A sensor or sensors are used at positions around the structure to measure the vibration response, and together with the input force, the frequency response functions are calculated. These give the magnitude and phase of the response to the input as a function of frequency. The first peak in the frequency response functions that is associated with a 180 degree change in phase is the first natural frequency.

For some applications it may not normally be necessary to calculate the specific first natural frequency of a structure because the applied the force may be pre-set a frequency well below an anticipated level. For example, in the case of building floors a device may be set to apply the force at a very low frequency (e.g. 2 Hz) and if a floor had a natural frequency that low it would be all but unserviceable.

In methods and/or devices formed in accordance with the present invention an inertial mass may be forced to oscillate thus generating reaction loads to excite the structure under test.

The driving force for the inertial mass may be provided by an electro-mechanical or hydraulic motor. The motor may, for example, be a linear motor.

The relative contribution from the stiffness of the structure to the response may be at least 70%, 80%, 90% or may be 100%. For example, the contribution to the dynamic response from the stiffness of the structure may be at least 90% and that from the mass may be less than 10%. The closer to 100/0, the lower is the error term cause by the mass effects from the floor. 90/10 is achievable. At 70/30 accuracy may be compromised.

The method/device may comprise measuring and/or providing means for measuring dynamic force applied to a structure.

One or more force sensors may be provided at an interface with the structure, for example at the interface between the device and the structure, for measuring the force being applied to the structure.

Means for determining the acceleration of an inertial mass may be provided to allow the force being applied to the structure to be calculated.

The means for determining the acceleration may comprise one or more of: a motion sensor; a position sensor; a velocity transducer; and an accelerometer.

The method/device may comprise measuring and/or providing a response sensor (or multiple response sensors) to measure the motion of the structure being loaded.

The response sensor may comprise one or more of: a position sensor; a velocity transducer; an accelerometer.

The method/device may comprise determining and/or providing means for determining the frequency-dependent ratio of response motion to excitation force.

Methods and devices formed in accordance with the present invention may use the cross-spectrum between the excitation force and the response motion together with the auto-spectrum of the excitation force to obtain the ratio.

Methods and devices formed in accordance with the present invention may use the cross-spectrum between the excitation force and the response motion together with the auto-spectrum of the response motion obtain the ratio.

The method/device may comprise means for estimating the static flexibility of a structure based on the ratio at a selected frequency.

The present invention also provides a building floor assessment method or device comprising a method or device as described herein.

The or each frequency used may, for example, be less than 10 Hz. For example the or each frequency may be approximately 2 Hz.

A further aspect provides a method to assess the integrity of a structure comprising the steps of: i) determining or estimating the first natural frequency of the structure; ii) applying a sinusoidally varying force to the structure at a frequency or frequencies below the first natural frequency of that structure to set up a dynamic response where the contribution from the stiffness of the structure is at least 90% and that from the mass is less than 10%; and iii) monitoring the dynamic response of the structure.

A further aspect of the present invention provides a method of assessing the integrity of a structure, comprising the steps of: i) applying an oscillating force to a structure; and ii) monitoring the dynamic response of the structure.

A further aspect provides a device for assessing the integrity of a structure, comprising the steps of: i) applying a sinusoidally varying force to a structure; and ii) monitoring the dynamic response of the structure.

A further aspect provides a method of applying a dynamic load into a flexible structure at a frequency or frequencies below the first natural frequency of that structure with the purpose of setting up a response dominated by the stiffness of the structure.

In aspect and embodiments of the present invention an inertial mass may be forced to oscillate thus generating reaction loads to excite the structure under test.

The driving force for the inertial mass may be provided by an electro-mechanical or hydraulic motor.

The motor may be a linear motor.

The force generated may be, or may be predominantly, generally sinusoidal. The force may, for example, be or may generate a sinusoidal waveform with a fixed frequency.

The device/method may include a principle of dynamic excitation (changing with time).

The device/method may be based on a principle of measuring/estimating/calculating/determining stiffness.

Methods or devices may comprise a step or means for measuring dynamic force applied to a structure.

One or more force sensors may be provided at the interface between a device and a structure for measuring the force being applied to the structure.

Means or a step may be provided for determining the acceleration of an inertial mass are provided to allow the force being applied to the structure to be calculated

The means or step for determining the acceleration may comprise the use of one or more of: a motion sensor; a position sensor; a velocity transducer; and an accelerometer.

The method or device may comprise a response sensor and/or a step for measuring the motion of the structure being loaded.

The response sensor may comprise one or more of: a position sensor; a velocity transducer; an accelerometer.

A method or device may comprise means for determining the frequency-dependent ratio of response motion to excitation force.

The method/device may use the cross-spectrum between the excitation force and the response motion together with the auto-spectrum of the excitation force to obtain the ratio.

The method/device may use the cross-spectrum between the excitation force and the response motion together with the auto-spectrum of the response motion obtain the ratio.

The method/device may comprise means or a step for estimating the static flexibility of a structure based on the ratio at a selected frequency.

The method may comprise means for improving the estimate of the static flexibility based on the first natural frequency of the structure.

The method/device may comprise means for improving the estimate of the static flexibility based on the damping ratio of the first natural mode.

The method/device may comprise means or a step for assembling the static flexibility values into a flexibility matrix.

The method/device may comprise means or a step for multiplying the flexibility matrix by a force vector to obtain a deflection vector.

The present invention also provides a floor assessment method comprising a method as described herein.

The present invention also provides a floor assessment device comprising a device as described herein.

A further aspect provides a device for applying a dynamic load into a flexible structure at a frequency or frequencies below the first natural frequency of that structure with the purpose of setting up a response dominated by the stiffness of the structure.

In aspects and embodiments of the present invention an inertial mass may be forced to oscillate thus generating reaction loads to excite a structure under test.

A driving force may be provided by an electro-mechanical and/or hydraulic motor. The motor may be a linear motor.

The force generated may be or may be predominantly sinusoidal.

The present invention also provides a method of measuring the dynamic force applied to the structure from the device as described herein.

A force sensor or sensors may be provided at the interface between the device and the structure for measuring the force being applied to the structure.

A motion sensor may be associated with the device to determine the acceleration of the inertial mass to allow the dynamic force to be calculated

A position sensor may be provided to measure the motion.

A velocity transducer may be provided to measure the motion.

An accelerometer may be provided to measure the motion.

A response sensor may be provided to measure the motion of the structure being loaded by the device.

A position sensor may be provided to measure the motion.

A velocity transducer may be provided to measure the motion.

An accelerometer may be provided to measure the motion.

The present invention also provides a method for determining the frequency dependent ratio of response motion to excitation force.

A method for obtaining the ratio may use the cross-spectrum between the excitation force and the response motion together with the auto-spectrum of the excitation force.

A method for obtaining the ratio may use the cross-spectrum between the excitation force and the response motion together with the auto-spectrum of the response motion.

The present invention also provides a method for estimating static flexibility based on the ratio at a selected frequency.

A method for improving the estimate of the static flexibility may be based on the first natural frequency of the structure.

A method for improving the estimate of the static flexibility may be based on the damping ratio of the first natural mode.

The present invention also provides a method for assembling static flexibility values determined into a flexibility matrix.

The flexibility matrix may be multiplied by a force vector to obtain a deflection vector.

Structures that could be tested to obtain flexibilities include:
Floors of buildings
Balustrades and handrails
Steps and stairways
Bridges
Walls
Balconies
Roofs
Towers
Monuments
Stadiums

Some aspects and embodiments of the present invention are based on applying a sinusoidally varying force and monitoring the dynamic response and using these signals to calculate the flexibility. This type of measurement is typically used in engineering applications in experimental modal analysis, often to help avoid resonances. The mathematical description of the ratio of response to excitation force is known as a Frequency Response Function, H(ω), and takes the form of a complex (magnitude and phase) pair of values as a function of frequency. H(ω) can be estimated from the force spectrum F(ω) and the response spectrum X(ω) as H₁(ω) the cross spectrum between the response and force divided by the auto spectrum of the force or H₂(ω) the auto spectrum of the response divided by the cross spectrum between the force and response.

$${H}_{1} ( ω ) = \frac{{G}_{XF} ( ω )}{{G}_{FF} ( ω )} = \frac{X ( ω ) {F ( ω )}^{*}}{F ( ω ) {F ( ω )}^{*}}$$

$${H}_{2} ( ω ) = \frac{{G}_{XX} ( ω )}{{G}_{XF} ( ω )} = \frac{X ( ω ) {X ( ω )}^{*}}{X ( ω ) {F ( ω )}^{*}}$$

Where * indicates the complex conjugate.

In a modal analysis, the frequency values of interest are the peaks in the spectrum which define the natural frequencies. The values of H(ω) at these points are influenced by the mass and stiffness properties of the structure being tested and the stiffness component alone cannot be extracted from the data. However, for excitation frequencies below the first natural frequency, the values of H(ω) become dominated by the static stiffness, k, according to the relationship:

$$H ( ω ) = \frac{1}{k} \frac{1}{\sqrt{{( 1 - {β}^{2} )}^{2} + {( 2 ξ β )}^{2}}}$$

Where: β is the ratio of excitation frequency to the first natural frequency, and ξ is the damping factor.

For the purpose of some embodiments, the value of β may be kept to no more than 0.25 and values of ξ may be never or rarely above 0.1. With these extreme parameters, the error in the stiffness measurement would be approximately 6%.

Some aspects and embodiments of the present invention can also be used to find the first natural frequency and so this error can be eliminated if required.

If Φ is static flexibility value and H_{ω} is the measured value of H(ω) at the frequency of the applied load (below the first mode frequency) then:

$$Φ = \frac{1}{k} = {H}_{ω} \times \sqrt{{( 1 - {β}^{2} )}^{2} + {( 2 ξ β )}^{2}}$$

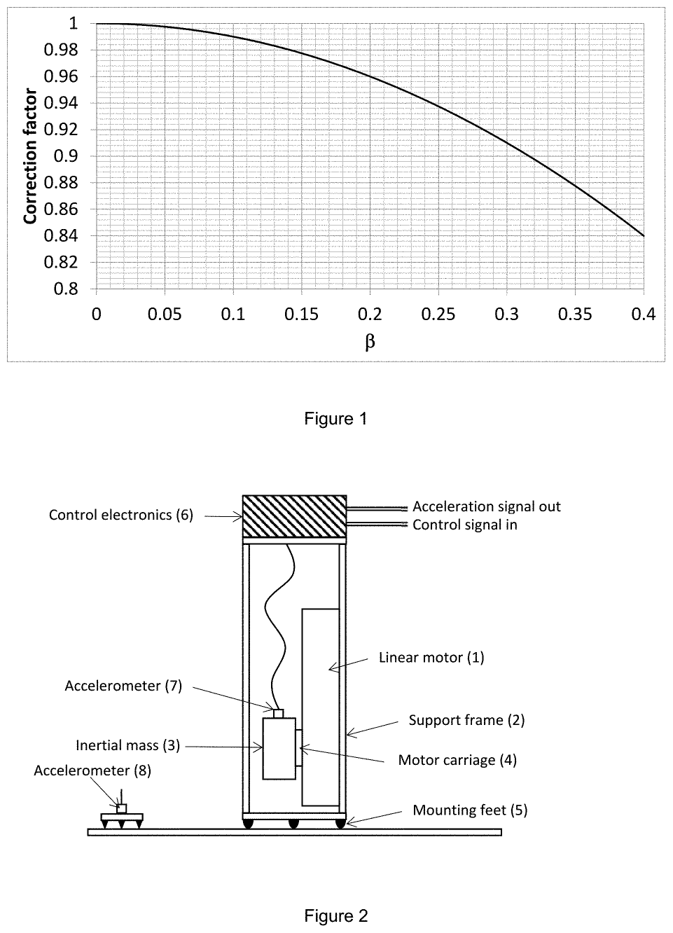

The damping factor ξ has a small effect on the correction factor which can therefore be approximated to (1−β²) and plotted as a function of β as shown in the chart of FIG. 1.

Further aspect and embodiments are set out in the following numbered paragraphs.
1. A device for applying a dynamic load into a flexible structure at a frequency or frequencies below the first natural frequency of that structure with the purpose of setting up a response dominated by the stiffness of the structure.
2. A device according to paragraph 1 where an inertial mass is forced to oscillate thus generating reaction loads to excite the structure under test.
3. A device according to paragraph 1 or 2 where the driving force is provided by an electro-mechanical or hydraulic motor.
4. A device according to paragraph 3 where the motor is a linear motor.
5. A device according to paragraphs 1-4 where the force generated is predominantly sinusoidal.
6. A method of measuring the dynamic force applied to the structure from the device of any of paragraphs 1-4.
7. A force sensor or sensors at the interface between the device and the structure for measuring the force being applied to the structure according to paragraph 6.
8. A motion sensor associated with the device to determine the acceleration of the inertial mass to allow the force described in paragraph 6 to be calculated
9. A position sensor to measure the motion described in paragraph 8.
10. A velocity transducer to measure the motion in paragraph 8.
11. An accelerometer to measure the motion in paragraph 8.
12. A response sensor to measure the motion of the structure being loaded by the device of paragraphs 1-4
13. A position sensor to measure the motion described in paragraph 12.
14. A velocity transducer to measure the motion in paragraph 12.
15. An accelerometer to measure the motion in paragraph 12.
16. A method for determining the frequency dependent ratio of response motion of paragraph 12 to excitation force of paragraph 6.
17. A method for obtaining the ratio of paragraph 16 that uses the cross-spectrum between the excitation force and the response motion together with the auto-spectrum of the excitation force.
18. A method for obtaining the ratio of paragraph 16 that uses the cross-spectrum between the excitation force and the response motion together with the auto-spectrum of the response motion.
19. A method for estimating the static flexibility based on the ratio of paragraph 16 at a selected frequency.
20. A method for improving the estimate of the static flexibility according to paragraph 19 based on the first natural frequency of the structure.
21. A method for improving the estimate of the static flexibility according to paragraph 20 based on the damping ratio of the first natural mode.
22. A method for assembling the static flexibility values determined according to paragraphs 19-21 into a flexibility matrix.
23. A method for multiplying the flexibility matrix of paragraph 22 by a force vector to obtain a deflection vector.

Different aspects and embodiments of the invention may be used separately or together.

Embodiments of the present invention are shown, by way of example, with reference to the accompanying drawings, in which:

FIG. 1 shows a chart of an exemplary dampening factor;

FIG. 2 shows an exemplary embodiment of the invention;

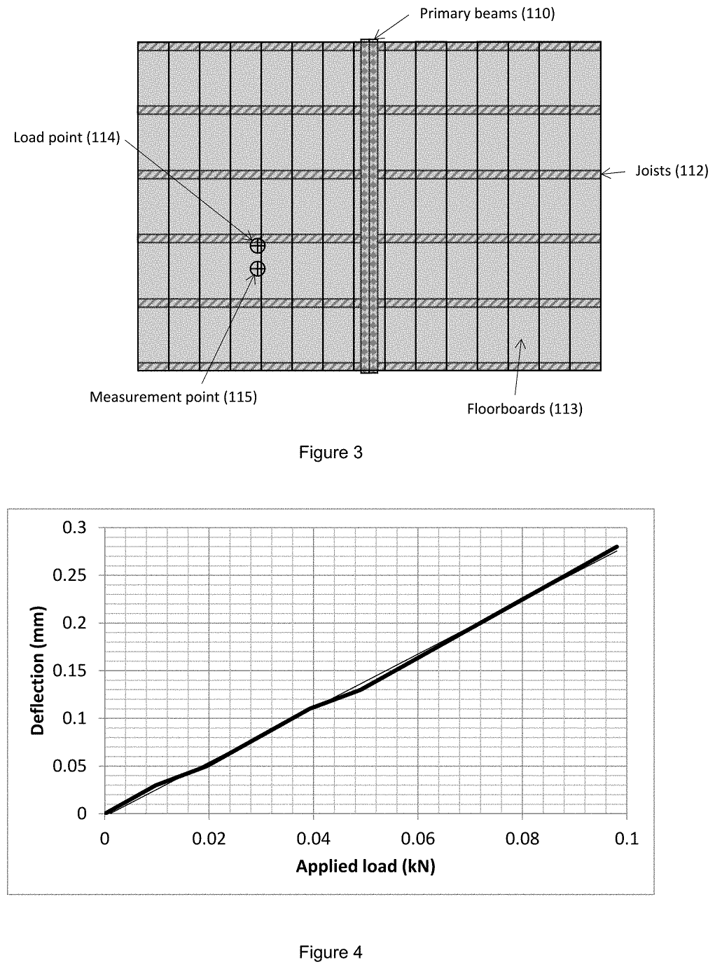

FIG. 3 illustrates an exemplary testing structure; and

FIG. 4 show a chart of an exemplary relationship between load and deflection.

The example embodiments are described in sufficient detail to enable those of ordinary skill in the art to embody and implement the systems and processes herein described. It is important to understand that embodiments can be provided in many alternative forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

Unless otherwise defined, all terms (including technical and scientific terms) used herein are to be interpreted as is customary in the art. It will be further understood that terms in common usage should also be interpreted as is customary in the relevant art and not in an idealised or overly formal sense unless expressly so defined herein.

In the following description, all orientational terms, such as upper, lower, radially and axially, are used in relation to the drawings and should not be interpreted as limiting on the invention.

Referring now to FIG. 2 an embodiment of the invention comprises a linear motor (1) supported in a stiff framework (2). A rigid mass (3) is attached to the carriage of the motor (4) so that any acceleration of that mass will result in reaction loads being applied to the support for the frame at the three feet (5). A motor controller (6) can accept drive signals that enable specific waveforms of force to be generated. In this embodiment, sinusoidal forces can be used for the flexibility measurement and typically random forces for determining the natural frequencies. The motor controller sets the acceleration of the carried mass, and this is directly proportional to the excitation force. An accelerometer (7) that is fitted to the inertial rigid mass outputs the acceleration signal from which the force can be calculated. A separate accelerometer (8) is fitted to the structure being tested and gives the response signal. The FRF, H(ω), is calculated at the excitation frequency by a separate software application and converted to the flexibility value Φ.

By the method outlined above, the deflection at location A from an excitation at location A can be measured. This gives the point flexibility value for A denoted by Φ_{AA}. In a similar way, the deflection at location B from excitation at location A can also be measured. This gives the cross flexibility between A and B denoted by Φ_{BA}. If the test includes n locations there are n² measurements of cross and point flexibility that can be measured. The assembly into matrix form is known as the flexibility matrix, [Φ].

If there is a proposed pattern of loads to be applied at the n locations, described by the force vector {F}, then the deformation at the n locations, described by the displacement vector {x}, will be given by:

{x}=[Φ]{F}

From the calculated displacements, other important structural integrity values such as stress and strain can be calculated.

Referring to FIG. 3, a wooden test floor was constructed that consisted of a pair of primary beams (110), a set of joists (112) and a covering of floorboards (113). The ends of the primary beams were simply supported and the joists were pinned to the primaries and simply supported at their free ends. A loading point was identified on the floor (114) with a measurement point (115) about 200 mm away.

A static load was applied to (114) using increments of mass of 1 kg up to 10 kg. The deflection of the floor was measured at (115) using a dial gauge. The relationship between load and deflection is shown in the chart of FIG. 4.

The gradient of the line in the chart is the flexibility between the load and measurement point and the value for the test was 2.84 mm/kN.

An embodiment of the invention (for example the embodiment of FIG. 2) was used to measure the flexibility between positions (114) and (115) using an excitation frequency of 2 Hz, and the value of 2.90 mm/kN was obtained. Further measurements showed that the first natural frequency of the floor was 18.85 Hz and the damping factor was 0.0112. The correction factor for these parameters is 0.989 giving the corrected flexibility value of 2.87 mm/kN which is less than 1% different from the value derived from the static test.

Although illustrative embodiments of the invention have been disclosed in detail herein, with reference to the accompanying drawings, it is understood that the invention is not limited to the precise embodiments shown and that various changes and modifications can be effected therein by one skilled in the art without departing from the scope of the invention as defined by the appended claims and their equivalents.

1. An integrity assessment method for a surface or structure, comprising the steps of:
i) forcing an inertial mass to oscillate thus generating reaction loads to excite a surface or structure under test and so as to apply a sinusoidally varying force to the surface or structure at a fixed frequency that is pre-set to be below an anticipated lowest frequency that could cause resonance in the surface or structure, whereby to set up a dynamic response dominated by the static stiffness of the surface or structure;
ii) providing a sensor to measure the excitation force being applied to the surface or structure;
iii) providing a separate sensor to measure the response motion of the surface or structure; and
iv) determining the ratio of response motion to excitation force at the excitation frequency.

2. A device to assess the static stiffness of a surface or structure, comprising:
i) means for applying a sinusoidally varying force to the surface or structure at a fixed frequency that is below the lowest frequency that could cause resonance in the surface or structure whereby to set up a dynamic response dominated by the static stiffness of the surface or structure; and
ii) means for monitoring the dynamic response of the surface or structure.

3. A method as claimed in claim 1, comprising a step of determining or estimating the first natural frequency of the floor whereby to determine or estimate the lowest frequency that could cause resonance in the floor.

4. (canceled)

5. (canceled)

6. A method as claimed in claim 1, where the relative contribution from the stiffness of the structure to the response is at least 90%.

7. A method as claimed in claim 1, comprising measuring dynamic force applied to a structure.

8. A method as claimed in claim 1, in which one or more force sensors are provided at an interface with the structure for measuring the force being applied to the structure.

9. A method as claimed in claim 1, in which the acceleration of an inertial mass is measured to allow the force being applied to the surface or structure to be calculated.

10. (canceled)

11. A method as claimed in claim 1, comprising measuring a response sensor to measure the motion of the surface or structure being loaded.

12-17. (canceled)

18. A method as claimed in claim 1, in which the frequency is less than 10 Hz.

19. A method as claimed in claim 1, in which the frequency is approximately 2 Hz.

20. A device as claimed in claim 2 and configured as a building floor integrity assessment device.

21. A method as claimed in claim 1 and configured as a building floor integrity assessment method.

22. Equipment that performs a stiffness assessment on a surface or structure, the equipment comprises a linear motor supported in a support frame, a rigid mass is attached to a carriage of the motor so that any acceleration of the mass will result in reaction loads being applied to the support frame.

23. Equipment as claimed in claim 22, in which a motor controller can accept drive signals that enable specific waveforms of force to be generated.

24. Equipment as claimed in claim 23, in which the motor controller sets the acceleration of the carried mass, and this is directly proportional to the excitation force.

25. Equipment as claimed in claim 22, in which the support frame has three feet.

26. Equipment as claimed in claim 22, in which an accelerometer is fitted to the inertial rigid mass and outputs the acceleration signal from which the force can be calculated.

27. Equipment as claimed in claim 22, comprising a separate accelerometer which is fitted to the surface or structure being tested and gives a response signal.

28. Equipment as claimed in claim 22, in which the FRF, H(ω), is calculated at the excitation frequency by a separate software application and converted to the flexibility value Φ.

29. Equipment as claimed in claim 22 and configured to assess a surface or structure selected from the group: floors of buildings; balustrades; handrails; steps; stairways; bridges; walls; balconies; roofs; towers; monuments; stadiums.
